(19) United States
(12) Patent Application Publication
(10) Pub. No.: US 2024/0414256 A1
(43) Pub. Date: Dec. 12, 2024

(54) RING KICKSTAND

(71) Applicant: Ziqi LIN, Guangzhou City (CN)

(72) Inventor: Ziqi LIN, Guangzhou City (CN)

(21) Appl. No.: 18/225,170

(22) Filed: Jul. 24, 2023

(30) Foreign Application Priority Data
Jun. 6, 2023 (CN) 202321432291.2

(51) Int. Cl. H04M 1/04

(52) U.S. Cl. CPC H04M 1/04

(57) ABSTRACT

A ring kickstand includes an annular base, and a ring buckle assembled in an inner hole of the annular base and rotatably connected to the annular base on one side. The annular base includes an outer ring body for being attached to a housing of a handheld electronic device, and an inner ring body assembled in an inner hole of the outer ring body. An inner ring surface of the outer ring body and an outer ring surface of the inner ring body are mutually compatible ring surfaces. The inner ring surface defines a closed-loop annular slide slot. The outer ring surface is symmetrically provided with sliders radially protruding out. The sliders are inserted and slidably received in the annular slide slot. The ring buckle is assembled in an inner hole of the inner ring body, and rotatably connected to the inner ring body through a shaft.

### BACKGROUND

### Field of the Present Invention

The present invention relates to supporting accessories for handheld electronic equipment and, more particularly to a ring kickstand.

### Background of the Present Invention

Generally, in order to facilitate the use of handheld electronic devices, such as mobile phones, users usually mount a ring kickstand on the casing (usually the rear shell) of the handheld electronic device.

A current ring kickstand generally includes an annular base, and a ring buckle assembled in an inner hole of the annular base and rotatably connected to the annular base on one side through means of a shaft. The ring buckle can not only be sleeved on the user's fingers to facilitate the user to hold the handheld electronic device, but also can be rotated and unfolded relative to the annular base to form a stand frame to facilitate the handheld electronic device to be placed on a desktop at an appropriate display angle.

However, the ring buckle of the current ring kickstand can only be rotated back and forth in a single direction about the shaft relative to the annular base to realize unfolding or folding, which is lack of multi-directional angle changes, and thus, it is still inconvenient to use.

### SUMMARY OF THE INVENTION

Therefore, the technical problem to be solved by the embodiments of the present invention is to provide a ring kickstand, which can realize multi-directional angle adjustment of a ring buckle.

To solve the above-mentioned technical problems, an embodiment of the present invention provides the following solutions. A ring kickstand includes an annular base, and a ring buckle assembled in an inner hole of the annular base and rotatably connected to the annular base on one side. The annular base includes an outer ring body for being attached to a housing of a handheld electronic device, and an inner ring body assembled in an inner hole of the outer ring body. An inner ring surface of the outer ring body and an outer ring surface of the inner ring body are mutually compatible ring surfaces. The inner ring surface of the outer ring body defines a closed-loop annular slide slot extending along a circumference of the inner ring surface. The outer ring surface of the inner ring body is symmetrically provided with sliders radially protruding out. The sliders are correspondingly inserted and slidably received in the annular slide slot. The ring buckle is assembled in the inner hole of the inner ring body, and rotatably connected to the inner ring body through a shaft.

Furthermore, the outer ring body includes an annular cover and an annular bottom bracket which are buckled up and down, the annular slide slot is defined in a junction of the annular cover and the annular bottom bracket; the sliders are limited through the annular cover and the annular bottom bracket respectively abutting against top and bottom surfaces of the sliders.

Furthermore, a position-limiting ring radially protrudes from an inner surface of the annular bottom bracket near a bottom surface of the annular bottom bracket, and a part of the annular cover close to the inner surface and located at a predetermined height position above the position-limiting ring cooperates with the position-limiting ring to form the annular slide slot; the top and bottom surfaces of the sliders are respectively abutted against a bottom of the annular cover and a top of the position-limiting ring.

Furthermore, the top of the position-limiting ring is a conical ring surface with a high outer ring and a low inner ring, and distal ends of the sliders form chamfers suitable for the conical ring surface.

Furthermore, an annular receiving slot is defined between the annular bottom bracket and the annular cover, surrounding the inner hole of the outer ring body and sealed by the annular bottom bracket and the annular cover; the annular receiving slot is assembled with a plurality of magnets arranged in a ring shape along the annular receiving slot.

Furthermore, the inner ring body defines a mounting slot that communicates with the inner hole of the inner ring body, and two opposite walls bounding the mounting slot define two coaxial shaft holes; a rotation seat protrudes from the side of the ring buckle to be inserted into the mounting slot, the rotation seat defines a through hole, the shaft extends through the through hole, and two ends of the shaft are respectively rotatably engaged in the shaft holes.

Furthermore, the sliders are a closed-loop ring edge.

Furthermore, the ring kickstand further includes an adhesive layer arranged on the bottom surface of the annular base, for bounding with the housing of the handheld electronic device.

Furthermore, overall thickness of the ring kickstand when the ring buckle is rotated to be stored in the annular base is not greater than 2.6 mm.

Furthermore, the annular base and the ring buckle are both made of plastic, and the annular cover and the annular bottom bracket are fastened together by ultrasonic welding process, buckle structure, screws, or adhesive fixed connection.

By adopting the above technical solution, embodiments of the present invention have at least the following beneficial effects. The closed-loop annular slide slot is defined in the inner ring surface of the outer ring body and along the circumferential direction of the inner ring surface, and the sliders radially protruding out are symmetrically arranged on the outer ring surface of the inner ring body. The sliders are correspondingly inserted and slidably received in the annular slide slot, so as that the inner ring body can rotate 360 degrees relative to the outer ring body about the central axis of the annular base. Furthermore, the ring buckle is rotatably connected to the inner ring body and can rotate about the shaft relative to the outer ring body. Therefore, the multi-directional angle adjustment of the ring buckle can be realized, and it is convenient to adjust a viewing angle of use when grasping the handheld electronic device or supporting the handheld electronic device on the desktop, which has strong practicability

### DESCRIPTION OF THE DRAWINGS

FIG. 1 is an assembled, isometric view of an embodiment of a ring kickstand including an annular ring and a ring buckle, showing the ring buckle being in a storage state.

FIG. 2 is similar to FIG. 1, but showing the ring buckle being in a support state.

FIG. 3 is an exploded, isometric view of FIG. 1.

FIG. 4 is a cross-sectional view of FIG. 1, taken along a central axis of an annular base, which shows the ring kickstand being attached to a housing of a handheld electronic device.

FIG. 5 is an enlarged view of a circled portion A of FIG. 4.

### DETAILED DESCRIPTION OF THE PRESENT INVENTION

The present application will be further described in detail below with reference to the accompanying drawings and embodiments. It should be understood that the following illustrative embodiments and illustrations are only used to explain the present invention and are not intended to limit the present invention, and that the embodiments of the present invention and the features of the embodiments can be combined with each other without conflict.

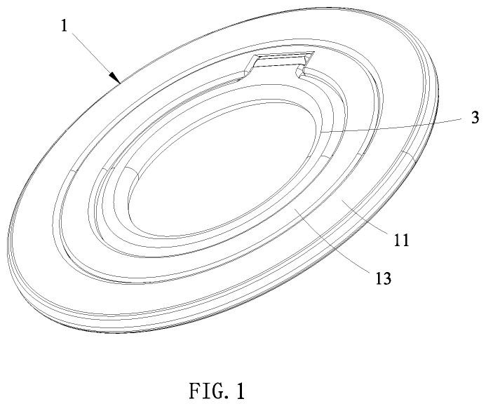

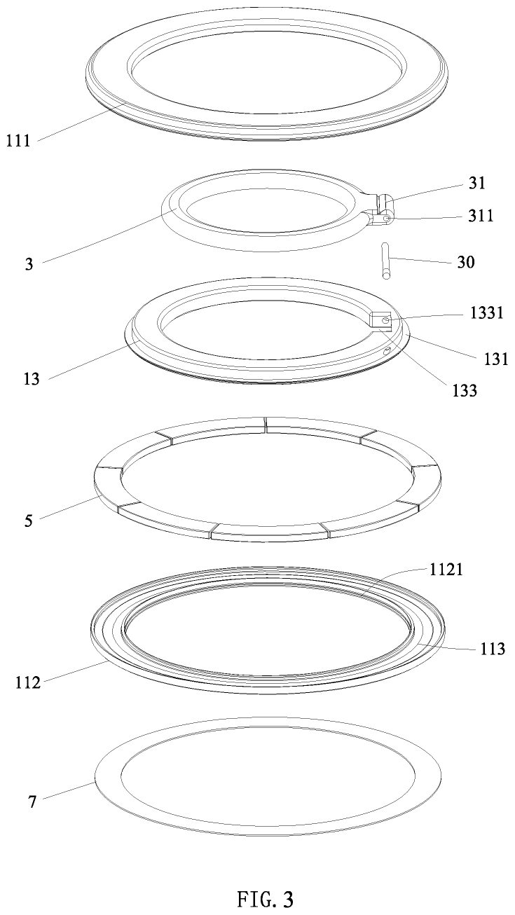

Referring to FIGS. 1-5, an embodiment of the present invention provides a ring kickstand including an annular base 1, and a ring buckle 3 assembled in an inner hole of the annular base 1 and rotatably connected to the annular base 1 on one side. The annular base 1 includes an outer ring body 11 for being attached to a housing 100 of a handheld electronic device, and an inner ring body 13 assembled in an inner hole of the outer ring body 11. An inner ring surface of the outer ring body 11 and an outer ring surface of the inner ring body 13 are mutually compatible ring surfaces. The inner ring surface of the outer ring body 11 defines a closed-loop annular slide slot 110 extending along the circumference of the inner ring surface. The outer ring surface of the inner ring body 13 is symmetrically provided with sliders 131 radially protruding out. The sliders 131 are correspondingly inserted and slidably received in the annular slide slot 110. The ring buckle 3 is assembled in the inner hole of the inner ring body 13, and rotatably connected to the inner ring body 13 by means of a shaft 30.

In use, when the inner ring body 13 is assembled in the inner hole of the outer ring body 11, a bottom surface of the inner ring body 13 is flush with or slightly higher than a bottom surface of the outer ring body 11. For the convenience of description, in the embodiment of the present invention, the ring kickstand is on the top, and the handheld electronic device is located below the ring kickstand to determine the corresponding orientation relationship. Therefore, the outer ring body 11 is correspondingly attached to a side surface of the housing 100 of the handheld electronic device, and a side surface of the inner ring body 13 facing the handheld electronic device is respectively regarded as the bottom surface. It can be understood that these descriptions and limitations on orientations are only for the convenience of describing and understanding related technical features, and should not be regarded as limiting the present invention.

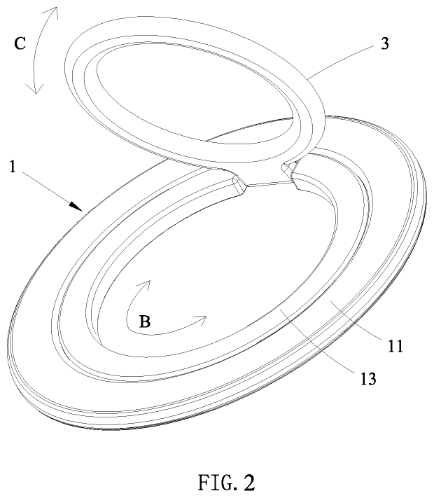

In the embodiment of the present invention, the closed-loop annular slide slot 110 is defined in the inner ring surface of the outer ring body 11 and along the circumferential direction of the inner ring surface, and the sliders 131 radially protruding out are symmetrically arranged on the outer ring surface of the inner ring body 13, the sliders 131 are correspondingly inserted and slidably received in the annular slide slot 110, so as that the inner ring body 13 can rotate 360 degrees relative to the outer ring body 11 about the central axis of the annular base 1, as shown by the two-way arrow B in FIG. 2, and furthermore, the ring buckle 3 is rotatably connected to the inner ring body 13 and can rotate about the shaft 30 relative to the outer ring body 11, as shown by the two-way arrow C in FIG. 2. Therefore, the multi-directional angle adjustment of the ring buckle 3 can be realized, and it is convenient to adjust a viewing angle of use when grasping the handheld electronic device or supporting the handheld electronic device on the desktop, which has strong practicability.

In an embodiment of the present invention as shown in FIGS. 1-5, the outer ring body 11 includes an annular cover 111 and an annular bottom bracket 112 which are buckled up and down. The annular slide slot 110 is defined in a junction of the annular cover 111 and the annular bottom bracket 112. The sliders 131 are limited through the annular cover 111 and the annular bottom bracket 112 respectively abutting against top and bottom surfaces of the sliders 131. In the embodiment, the outer ring body 11 is a split structure. Specifically, the outer ring body 11 includes the annular cover 111 and the annular bottom bracket 112 that are buckled to each other, and the annular slide slot 110 is defined in the junction of the annular cover 111 and the annular bottom bracket 112, which is convenient for forming the annular slide slot 110. In assembling the sliders 131 to the outer ring body 11, the annular cover 111 and the annular bottom bracket 112 are respectively abutted against the top and bottom surfaces of the sliders 131 to limit the sliders 131, and thus, the limit structure is simple and compact.

In an embodiment of the present invention as shown in FIGS. 1-5, a position-limiting ring 1121 radially protrudes from the inner surface of the annular bottom bracket 112 near the bottom surface of the annular bottom bracket 112, and a part of the annular cover 111 close to the inner surface and located at a predetermined height position above the position-limiting ring 1121 cooperates with the position-limiting ring 1121 to form the annular slide slot 110. The top and bottom surfaces of the sliders 131 are respectively abutted against the bottom of the annular cover 111 and the top of the position-limiting ring 1121. In the embodiment, the sliders 131 of the inner ring body 13 are first abutted against the position-limiting ring 1121, and then the annular cover 111 is assembled to the annular bottom bracket 112, to finally limit the sliders 131 through the bottom of the annular cover 111. Through the position-limiting ring 1121 protruding radially on the annular bottom bracket 112, the assembly structure is simple and easy to process.

In an embodiment of the present invention as shown in FIGS. 1-5, the top of the position-limiting ring 1121 is a conical ring surface 11210 with a high outer ring and a low inner ring, and distal ends of the sliders 131 form chamfers 1311 suitable for the conical ring surface 11210. In the embodiment, the conical ring surface 11210 and the chamfers 1311 with matching shapes are provided on the position-limiting ring 1121 and the sliders 131 respectively, so as that after the distal ends of the sliders 131 are correspondingly inserted into the top of the position-limiting ring 1121 and the bottom of the annular cover 111, the chamfers 1311 cooperate with the conical ring surface 11210 to realize the limit, which effectively avoids the falling of the inner ring body 13, and which is beneficial to reduce the overall thickness of the annular base 1.

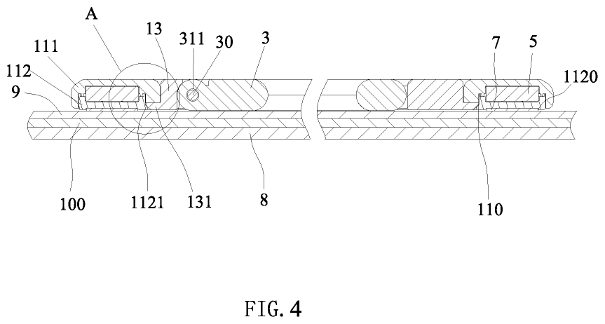

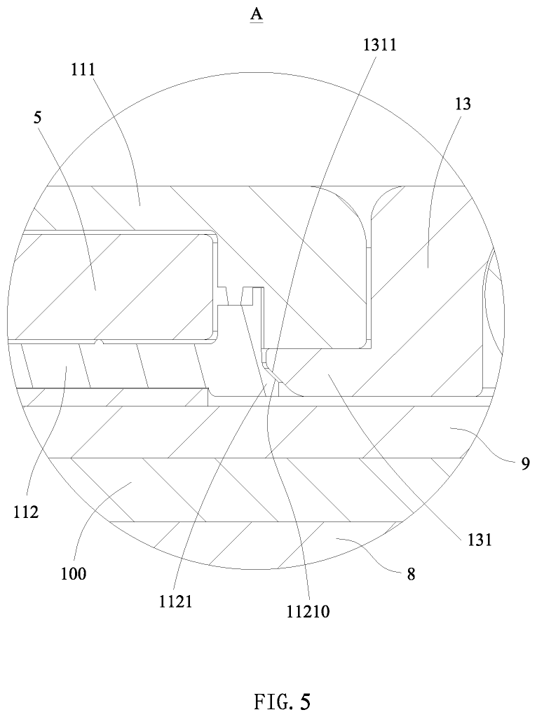

In an embodiment of the present invention as shown in FIGS. 1-5, an annular receiving slot 113 is defined between the annular bottom bracket 112 and the annular cover 111, surrounding the inner hole of the outer ring body 11 and sealed by the annular bottom bracket 112 and the annular cover 111. The annular receiving slot 113 is assembled with a plurality of magnets 5 arranged in a ring shape along the annular receiving slot 113. The annular base 1 can be directly adsorbed on the housing 100 of the handheld electronic device by means of magnetic attraction, which is convenient for assembly and disassembly. Furthermore, the annular base 1 can also be magnetically adsorbed on other external objects that can be magnetically adsorbed by means of the magnet 5, such as car holders, refrigerators, desktops, and other objects made of magnetically adsorbable materials, so that the handheld electronic device is supported and fixed on corresponding objects, which facilitates the use of the handheld electronic device in various occasions. In the embodiment shown in FIG. 4 and FIG. 5, the top of the annular bottom bracket 112 and the bottom of the annular cover 111 define two slots, respectively, and when the annular bottom bracket 112 and the annular cover 111 are buckled together, the two slots face to each other and are spliced to completely form the annular receiving slot 113. In a specific implementation, the annular receiving slot 113 can also be directly defined only in the top of the annular bottom bracket 112 or in the bottom of the annular cover 111, and the corresponding annular cover 111 or annular bottom bracket 112 only plays the role of correspondingly covering and sealing the annular receiving slot 113.

In an embodiment of the present invention, as shown in FIGS. 1-5, the inner ring body 13 defines a mounting slot 133 that communicates with the inner hole of the inner ring body 13, and two opposite walls bounding the mounting slot 133 define two coaxial shaft holes 1331. A rotation seat 31 protrudes from a side of the ring buckle 3 to be inserted into the mounting slot 133. The rotation seat 31 defines a through hole 311. The shaft 30 extends through the through hole 311, and two ends of the shaft 30 are respectively rotatably engaged in the shaft holes 1331 in the opposite walls bounding the mounting slot 133. In the embodiment, the mounting slot 133 is defined in a wall bounding the inner hole of the inner ring body 13, and the rotation seat 31 of the ring buckle 3 is inserted into the mounting slot 133, which optimizes the structure of the ring buckle 3, and reduces the space occupied by the ring buckle 3 in the inner hole of the inner ring body 13, making the structure of the ring kickstand more compact. Furthermore, in specific implementation, by designing the shaft 30 and the shaft hole 1331 as an interference fit, the ring buckle 3 has a better damping positioning effect when rotating relative to the rotation seat 31, and it is convenient to realize positioning support at any angle of rotation.

In an embodiment of the present invention, as shown in FIGS. 1-5, the sliders 131 are a closed-loop ring edge. In the embodiment, the sliders 131 are designed as a closed-loop ring edge, which is convenient for integral molding, and the entire circle of the sliders 131 is kept in contact with walls bounding the annular slide slot 110 to ensure that the inner ring body 13 rotating relative to the outer ring body 11 has better stability. Of course, it can be understood that the sliders 131 can also be provided only two or three mutually symmetrical predetermined positions, which can also effectively guide the inner ring body 13 to rotate relative to the outer ring body 11.

In an embodiment of the present invention, as shown in FIGS. 1-5, the ring kickstand further includes an adhesive layer 7 arranged on the bottom surface of the annular base 1, for bounding with the housing 100 of the handheld electronic device. In the embodiment, the adhesive layer 7 is arranged on the bottom of the annular bottom bracket 112 away from the annular cover 111, and the ring kickstand can be directly bonded to the housing 100 of the handheld electronic device through the adhesive layer 7. In specific implementation, since the adhesive layer 7 needs to have an appropriate thickness to have a relatively stable pasting effect, for the convenience of setting the adhesive layer 7 and reducing the overall thickness of the ring kickstand, the bottom surface of the annular bottom bracket 112 can define a receiving groove 1120 with a depth slightly less than the thickness of the adhesive layer 7, to accommodate the adhesive layer 7, so as that the bottom surface of the adhesive layer 7 protrudes slightly from the bottom of the annular bottom bracket 112.

In an embodiment of the present invention, as shown in FIGS. 1-5, the overall thickness of the ring kickstand when the ring buckle 3 is rotated to be stored in the annular base 1 is not greater than 2.6 mm. Current handheld electronic devices, such as mobile phones, are provided with a wireless charging module 8 on the inner surface of the housing 100 (usually the rear wall). Under the current wireless charging technical conditions, because of the small thickness of the housing 100 of the handheld electronic device, wireless charging can be realized when the outer surface of the housing 100 of the handheld electronic device and the external wireless charger is kept within an effective charging distance of 4.6 mm. Because the ring kickstand is attached to the outer surface of the housing 100 (usually the rear wall), in order not to affect the wireless charging function, the overall thickness of the ring kickstand when the ring buckle 3 is rotated to be stored in the annular base 1 in the embodiment is not greater than 2.6 mm, it will not adversely affect the wireless charging function of handheld electronic devices. In specific implementation, as shown in FIG. 4 and FIG. 5, even if the housing 100 of the handheld electronic device is covered with a protective shell 9, and the ring kickstand is attached to the outer surface of the protective shell 9, the thickness of the protective shell 9 only needs to be no more than 2 mm, the outer surface of the housing 100 of the handheld electronic device and the external wireless charger can still be kept within 4.6 mm. Therefore, the handheld electronic device can still effectively realize wireless charging when the protective shell 9 is covered on the handheld electronic device and the ring kickstand is attached to the out surface of the protective shell 9, without removing the protective shell 9 or the ring kickstand during wireless charging, which is more convenient to use. Under the current molding process conditions, the overall thickness of the ring kickstand is preferably 2.4-2.5 mm.

In an embodiment of the present invention, the annular base 1 and the ring buckle 3 are both made of plastic, and the annular cover 111 and the annular bottom bracket 112 are fastened together by ultrasonic welding process, buckle structure, screws, or adhesive fixed connection. In the embodiment, the annular cover 111, the annular bottom bracket 112, and the inner ring body 13 are all made of plastic material, which will not form electromagnetic shielding or interference to the wireless charging function of the handheld electronic device. In specific implementation, the annular cover 111, the annular bottom bracket 112, and the inner ring body 13 are injection molded by high-end injection molding machines, which is easy to process and has a good molding effect. The annular cover 111 and the annular bottom bracket 112 can also be connected into one body by ultrasonic welding process after being covered with each other, which not only has high assembly efficiency, high connection strength, and is not easy to loosen, but also the overall appearance of the finished product is more beautiful. Of course, the annular cover 111 and the annular bottom bracket 112 can also be fixedly connected by a buckle structure, screws, or glue, and the assembly is simple and efficient.

The embodiments of the present invention have been described above with reference to the accompanying drawings, but the present invention is not limited to the specific implementations described above, and the specific implementations described above are only schematic and not limiting. Under the enlightenment of this invention, many forms can be made without departing from the scope of this invention and the scope of protection of the claims, and these are all included in the scope of protection of this invention.

What is claimed is:

1. A ring kickstand, comprising:
an annular base comprising an outer ring body for being attached to a housing of a handheld electronic device, and an inner ring body assembled in an inner hole of the outer ring body, wherein an inner ring surface of the outer ring body and an outer ring surface of the inner ring body are mutually compatible ring surfaces, the inner ring surface of the outer ring body defines a closed-loop annular slide slot extending along a circumference of the inner ring surface, the outer ring surface of the inner ring body is symmetrically provided with sliders radially protruding out; the sliders are correspondingly inserted and slidably received in the annular slide slot; and
a ring buckle assembled in an inner hole of the inner ring body, and rotatably connected to the annular base on one side through a shaft.

2. The ring kickstand of claim 1, wherein the outer ring body comprises an annular cover and an annular bottom bracket which are buckled up and down, the annular slide slot is defined in a junction of the annular cover and the annular bottom bracket; the sliders are limited through the annular cover and the annular bottom bracket respectively abutting against top and bottom surfaces of the sliders.

3. The ring kickstand of claim 2, wherein a position-limiting ring radially protrudes from an inner surface of the annular bottom bracket near a bottom surface of the annular bottom bracket, and a part of the annular cover close to the inner surface and located at a predetermined height position above the position-limiting ring cooperates with the position-limiting ring to form the annular slide slot; the top and bottom surfaces of the sliders are respectively abutted against a bottom of the annular cover and a top of the position-limiting ring.

4. The ring kickstand of claim 3, wherein the top of the position-limiting ring is a conical ring surface with a high outer ring and a low inner ring, and distal ends of the sliders form chamfers suitable for the conical ring surface.

5. The ring kickstand of claim 2, wherein an annular receiving slot is defined between the annular bottom bracket and the annular cover, surrounding the inner hole of the outer ring body and sealed by the annular bottom bracket and the annular cover; the annular receiving slot is assembled with a plurality of magnets arranged in a ring shape along the annular receiving slot.

6. The ring kickstand of claim 1, wherein the inner ring body defines a mounting slot that communicates with the inner hole of the inner ring body, and two opposite walls bounding the mounting slot define two coaxial shaft holes; a rotation seat protrudes from the side of the ring buckle to be inserted into the mounting slot, the rotation seat defines a through hole, the shaft extends through the through hole, and two ends of the shaft are respectively rotatably engaged in the shaft holes.

7. The ring kickstand of claim 1, wherein the sliders are a closed-loop ring edge.

8. The ring kickstand of claim 1, further comprising an adhesive layer arranged on a bottom surface of the annular base, for bounding with the housing of the handheld electronic device.

9. The ring kickstand of claim 1, wherein overall thickness of the ring kickstand when the ring buckle is rotated to be stored in the annular base is not greater than 2.6 mm.

10. The ring kickstand of claim 2, wherein the annular base and the ring buckle are both made of plastic, and the annular cover and the annular bottom bracket are fastened together by ultrasonic welding process, buckle structure, screws, or adhesive fixed connection.
